(19) United States
(12) Patent Application Publication
(10) Pub. No.: US 2021/0188276 A1
(43) Pub. Date: Jun. 24, 2021

(54) VEHICLE CONTROL DATA GENERATING METHOD, VEHICLE CONTROLLER, VEHICLE CONTROL SYSTEM, AND VEHICLE LEARNING DEVICE

(71) Applicant: TOYOTA JIDOSHA KABUSHIKI KAISHA, Toyota-shi (JP)

(72) Inventors: Yosuke HASHIMOTO, Nagakute-shi (JP); Akihiro KATAYAMA, Toyota-shi (JP); Yuta OSHIRO, Nagoya-shi (JP); Kazuki SUGIE, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 17/120,936

(22) Filed: Dec. 14, 2020

(30) Foreign Application Priority Data
Dec. 20, 2019 (JP) 2019-230016
Dec. 26, 2019 (JP) 2019-236065

(51) Int. Cl. B60W 30/18; G01C 21/00; B60W 60/00; B60W 40/105

(52) U.S. Cl. CPC B60W 30/18163; G01C 21/3815; B60W 2520/105; B60W 60/001; B60W 40/105; G01C 21/3848

(57) ABSTRACT

A CPU uses relationship-defining data to set a throttle command value and a gear ratio command value on the basis of time-series data of an accelerator operation amount, a vehicle speed, and a gear ratio. The CPU operates a throttle valve and a transmission in accordance with the throttle command value and the gear ratio command value and obtains a rotation speed, a torque, a torque command value, and an acceleration at that time. When a predetermined amount of time is completed, the CPU updates the relationship-defining data by providing a reward depending on whether the torque and the acceleration meet standards. The CPU changes the reward depending on whether a position is a merging point.

### BACKGROUND

### 1. Field

The present disclosure relates to a vehicle control data generating method, a vehicle controller, a vehicle control system, and a vehicle learning device.

### 2. Description of Related Art

Japanese Laid-Open Patent Publication No. 2016-6327 discloses a controller that controls a throttle valve on the basis of a value obtained by subjecting an operation amount of an accelerator pedal to a filtering process.

The filter used in the filtering process needs to be set the operation amount of the throttle valve to an appropriate operation amount in accordance with the operation amount of the accelerator pedal. Thus, adaptation of the filter requires a large number of man-hours by skilled workers. In this manner, adaptation of operation amounts of electronic devices on a vehicle in accordance with the state of the vehicle requires a large number of man-hours by skilled workers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a vehicle control data generating method uses a memory device and an execution device. The method includes storing, in the memory device, relationship-defining data that defines a relationship between a state of a vehicle and an action variable related to an operation of an electronic device in the vehicle. Also, the method includes causing, with the relationship-defining data stored in the memory device, the execution device to execute: an obtaining process that obtains the state of the vehicle based on a detection value of a sensor and a road variable that identifies a road on which the vehicle is traveling; an operation process that operates the electronic device; a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard; and an update process that updates the relationship-defining data by inputting, to a predetermined update map, the state of the vehicle obtained by the obtaining process, the value of the action variable used to operate the electronic device, and the reward corresponding to the operation of the electronic device. The update map outputs the relationship-defining data that has been updated to increase an expected return of the reward of a case in which the electronic device is operated in accordance with the relationship-defining data. Values of the road variable include at least a first value and a second value. The reward calculating process includes a changing process that changes the reward, that is provided when the vehicle has a predetermined characteristic in a case in which the road variable has the second value, in relation to the reward that is provided when the vehicle has the predetermined characteristic in a case in which the road variable has the first value.

The above-described method calculates a reward that accompanies operation of the electronic device, so as to acquire the type of the reward obtained through that operation. Then, the relationship-defining data is updated on the basis of the reward, using the update map according to reinforcement learning. This sets an appropriate relationship between the state of the vehicle and the action variable. This reduces the man-hours required for skilled workers when setting an appropriate relationship between the state of the vehicle and the action variable.

Requirements for a vehicle can vary depending on whether the road is a general road or an expressway, whether the vehicle is at a merging point, whether the gradient of the road is large, and whether the curvature of the road is large. Accordingly, the above-described method changes the manner in which the reward is provided in accordance with the road variable. This allows relationship-defining data appropriate for the road to be learned through reinforcement learning.

In the above-described vehicle control data generating method, the road variable identifies that a position is a merging point, at which a general road merges into an expressway, and that a position is on a general road. The reward calculating process includes two processes, which are: a process that provides a greater reward when a standard related to acceleration response is met than when the standard related to acceleration response is not met; and a process that provides a greater reward when an energy use efficiency is high than when the energy use efficiency is low. The changing process includes a process that changes at least one of the two processes such that, in order to obtain a great reward, it is more advantageous to increase the acceleration response at the merging point than to increase the acceleration response on the general road.

The above-described configuration allows relationship-defining data that improves the acceleration response at a merging point to be learned through reinforcement learning.

The above-described vehicle control data generating method further includes, on a basis of the relationship-defining data that has been updated by the update process, causing the execution device to establish a correspondence between the state of the vehicle and a value of the action variable that maximizes the expected return, thereby generating control map data, wherein the control map data receives the state of the vehicle as an input, and outputs the value of the action variable that maximizes the expected return.

The above-described method generates control map data on the basis of the relationship-defining data, which has been learned through reinforcement learning. Thus, by providing the controller with the control map data, the value of the action variable that maximizes the expected return is easily set on the basis of the state of the vehicle and the action variable.

In a second general aspect, a vehicle controller includes a memory device and an execution device, and is configured to store, in the memory device, relationship-defining data that defines a relationship between a state of a vehicle and an action variable related to an operation of an electronic device in the vehicle. Also, the vehicle controller is configured to cause, with the relationship-defining data stored in the memory device, the execution device to execute: an obtaining process that obtains the state of the vehicle based on a detection value of a sensor and a road variable that identifies a road on which the vehicle is traveling; an operation process that operates the electronic device; a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard; and an update process that updates the relationship-defining data by inputting, to a predetermined update map, the state of the vehicle obtained by the obtaining process, the value of the action variable used to operate the electronic device, and the reward corresponding to the operation of the electronic device. The update map outputs the relationship-defining data that has been updated to increase an expected return of the reward of a case in which the electronic device is operated in accordance with the relationship-defining data. Values of the road variable include at least a first value and a second value. The reward calculating process includes a changing process that changes the reward, that is provided when the vehicle has a predetermined characteristic in a case in which the road variable has the second value, in relation to the reward, that is provided when the vehicle has the predetermined characteristic in a case in which the road variable has the first value. The operation process includes a process that operates the electronic device on a basis of the relationship-defining data and in accordance with a value of the action variable that corresponds to the state of the vehicle.

With the above-described configuration, the value of the action variable is set on the basis of the relationship-defining data, which is learned through reinforcement learning. The electronic device is operated on the basis of that set value. This allows the electronic device to be operated to increase the expected return.

In a third general aspect, a vehicle control system includes an execution device and a memory device, and is configured to store, in the memory device, relationship-defining data that defines a relationship between a state of a vehicle and an action variable related to an operation of an electronic device in the vehicle. Also, the vehicle control system is configured to cause, with the relationship-defining data stored in the memory device, the execution device to execute: an obtaining process that obtains the state of the vehicle based on a detection value of a sensor and a road variable that identifies a road on which the vehicle is traveling; an operation process that operates the electronic device; a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard; and an update process that updates the relationship-defining data by inputting, to a predetermined update map, the state of the vehicle obtained by the obtaining process, the value of the action variable used to operate the electronic device, and the reward corresponding to the operation of the electronic device. The update map outputs the relationship-defining data that has been updated to increase an expected return of the reward of a case in which the electronic device is operated in accordance with the relationship-defining data. Values of the road variable include at least a first value and a second value. The reward calculating process includes a changing process that changes the reward, that is provided when the vehicle has a predetermined characteristic in a case in which the road variable has the second value, in relation to the reward, that is provided when the vehicle has the predetermined characteristic in a case in which the road variable has the first value. The operation process includes a process that operates the electronic device on a basis of the relationship-defining data and in accordance with a value of the action variable that corresponds to the state of the vehicle. The execution device includes a first execution device mounted on the vehicle and a second execution device that is an out-of-vehicle device. The first execution device executes at least the obtaining process and the operation process. The second execution device executes at least the update process.

The above-described configuration executes the update process using the second execution device. Thus, as compared to a case in which the update process is executed using the first execution device, the computation load on the first execution device is reduced.

The phrase “the second execution device that is an out-of-vehicle device” means that the second execution device is not an in-vehicle device.

In a fourth general aspect, a vehicle controller is employed in a vehicle control system. The vehicle control system includes an execution device and a memory device. The vehicle controller is configured to store, in the memory device, relationship-defining data that defines a relationship between a state of a vehicle and an action variable related to an operation of an electronic device in the vehicle. The vehicle controller is configured to cause, with the relationship-defining data stored in the memory device, the execution device to execute: an obtaining process that obtains the state of the vehicle based on a detection value of a sensor and a road variable that identifies a road on which the vehicle is traveling; an operation process that operates the electronic device; a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard; and an update process that updates the relationship-defining data by inputting, to a predetermined update map, the state of the vehicle obtained by the obtaining process, the value of the action variable used to operate the electronic device, and the reward corresponding to the operation of the electronic device. The update map outputs the relationship-defining data that has been updated to increase an expected return of the reward of a case in which the electronic device is operated in accordance with the relationship-defining data. Values of the road variable include at least a first value and a second value. The reward calculating process includes a changing process that changes the reward, that is provided when the vehicle has a predetermined characteristic in a case in which the road variable has the second value, in relation to the reward, that is provided when the vehicle has the predetermined characteristic in a case in which the road variable has the first value. The operation process includes a process that operates the electronic device on a basis of the relationship-defining data and in accordance with a value of the action variable that corresponds to the state of the vehicle. The execution device includes a first execution device mounted on the vehicle and a second execution device that is an out-of-vehicle device. The first execution device executes at least the obtaining process and the operation process. The second execution device executes at least the update process. The includes the first execution device.

In a fifth general aspect, a vehicle learning device is employed in a vehicle control system. The vehicle control system includes an execution device and a memory device. The vehicle controller is configured to store, in the memory device, relationship-defining data that defines a relationship between a state of a vehicle and an action variable related to an operation of an electronic device in the vehicle. Also, the vehicle controller is configured to cause, with the relationship-defining data stored in the memory device, the execution device to execute: an obtaining process that obtains the state of the vehicle based on a detection value of a sensor and a road variable that identifies a road on which the vehicle is traveling; an operation process that operates the electronic device; a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard; and an update process that updates the relationship-defining data by inputting, to a predetermined update map, the state of the vehicle obtained by the obtaining process, the value of the action variable used to operate the electronic device, and the reward corresponding to the operation of the electronic device. The update map outputs the relationship-defining data that has been updated to increase an expected return of the reward of a case in which the electronic device is operated in accordance with the relationship-defining data. Values of the road variable include at least a first value and a second value. The reward calculating process includes a changing process that changes the reward, that is provided when the vehicle has a predetermined characteristic in a case in which the road variable has the second value, in relation to the reward, that is provided when the vehicle has the predetermined characteristic in a case in which the road variable has the first value. The operation process includes a process that operates the electronic device on a basis of the relationship-defining data and in accordance with a value of the action variable that corresponds to the state of the vehicle. The execution device includes a first execution device mounted on the vehicle and a second execution device that is an out-of-vehicle device. The first execution device executes at least the obtaining process and the operation process. The second execution device executes at least the update process. The vehicle learning device includes the second execution device.

Other features and aspects will be apparent from the following detailed description, the drawings, and the claims.

### BRIEF DESCRIPTION OF THE DRAWINGS

FIG. 1 is a diagram showing a controller according to a first embodiment of the present disclosure and a drive system.

FIG. 2 is a flowchart showing a procedure of processes executed by the controller.

FIG. 3 is a diagram showing a system that generates mapping data.

FIG. 4 is a flowchart showing a procedure of processes executed by the system.

FIG. 5 is a detailed flowchart showing a procedure of a learning process.

FIG. 6 is a flowchart showing a procedure of a mapping data generating process.

FIG. 7 is a diagram showing a controller according to a second embodiment and a drive system.

FIG. 8 is a flowchart showing a procedure of processes executed by the controller.

FIG. 9 is a diagram showing a system according to a third embodiment.

FIGS. 10A and 10B are flowcharts showing a procedure of processes executed by the system.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A vehicle control data generating method, a vehicle controller, a vehicle control system, and a vehicle learning device according to embodiments will now be described with refence to the drawings.

### First Embodiment

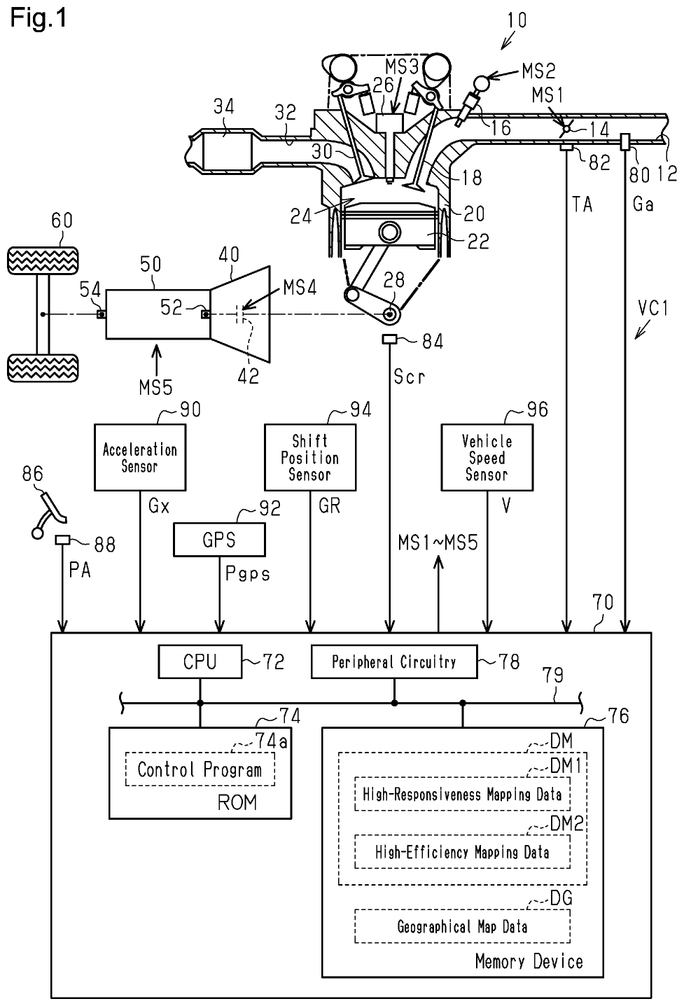

FIG. 1 shows the configuration of a drive system of a vehicle VC1 and a controller according to a first embodiment.

As shown in FIG. 1, an internal combustion engine 10 includes an intake passage 12, in which a throttle valve 14 and a fuel injection valve 16 are arranged in that order from the upstream side. Air drawn into the intake passage 12 and fuel injected from the fuel injection valve 16 flow into a combustion chamber 24, which is defined by a cylinder 20 and a piston 22, when an intake valve 18 is opened. In the combustion chamber 24, air-fuel mixture is burned by spark discharge of an ignition device 26. The energy generated by the combustion is converted into rotational energy of a crankshaft 28 via the piston 22. The burned air-fuel mixture is discharged to an exhaust passage 32 as exhaust gas when an exhaust valve 30 is opened. The exhaust passage 32 incorporates a catalyst 34, which is an aftertreatment device for purifying exhaust gas.

The crankshaft 28 is configured to be mechanically coupled to an input shaft 52 of a transmission 50 via a torque converter 40 equipped with a lockup clutch 42. The transmission 50 controls a gear ratio, which is the ratio between the rotation speed of the input shaft 52 and the rotation speed of an output shaft 54. The output shaft 54 is mechanically coupled to driven wheels 60.

A controller 70 controls the internal combustion engine 10. The controller 70 operates operated units of the internal combustion engine 10, such as the throttle valve 14, the fuel injection valve 16, and the ignition device 26, thereby controlling, for example, the torque and the ratios of exhaust components. The controller 70 also controls the torque converter 40. The controller 70 operates the lockup clutch 42 to control the engagement state of the lockup clutch 42. The controller 70 also controls the transmission 50. The controller 70 controls the transmission 50, thereby controlling the gear ratio. FIG. 1 shows operation signals MS1 to MS5 respectively corresponding to the throttle valve 14, the fuel injection valve 16, the ignition device 26, the lockup clutch 42, and the transmission 50.

To control the internal combustion engine 10, the controller 70 refers to an intake air amount Ga detected by an air flow meter 80, an opening degree of the throttle valve 14 detected by a throttle sensor 82 (throttle opening degree TA), and an output signal Scr of a crank angle sensor 84. The controller 70 also refers to a depression amount of an accelerator pedal 86 (accelerator operation amount PA) detected by an accelerator sensor 88 and an acceleration Gx in the front-rear direction of the vehicle VC1 detected by an acceleration sensor 90. The controller 70 further refers to positional data Pgps obtained by a global positioning system (GPS 92), a gear ratio GR detected by a shift position sensor 94, and a vehicle speed V detected by a vehicle speed sensor 96.

The controller 70 includes a CPU 72, a ROM 74, a nonvolatile memory that can be electrically rewritten (memory device 76), and peripheral circuitry 78. The CPU 72, the ROM 74, the memory device 76, and the peripheral circuitry 78 are connected together through a local network 79 to communicate with one another. The peripheral circuitry 78 includes a circuit that generates a clock signal regulating internal operations, a power supply circuit, and a reset circuit.

The ROM 74 stores a control program 74a. The memory device 76 also stores mapping data DM and geographical map data DG. The input variables of the mapping data DM include time-series data of the current gear ratio GR, the vehicle speed V, and the accelerator operation amount PA. The output variables of the mapping data DM are a throttle command value TA*, which is a command value for the throttle opening degree TA, and a gear ratio command value GR*, which is a command value for the gear ratio GR. The mapping data DM include high-responsiveness mapping data DM1 and high-efficiency mapping data DM2. Mapping data includes combinations of discrete values of input variables and values of output variables each corresponding to a value of the input variables.

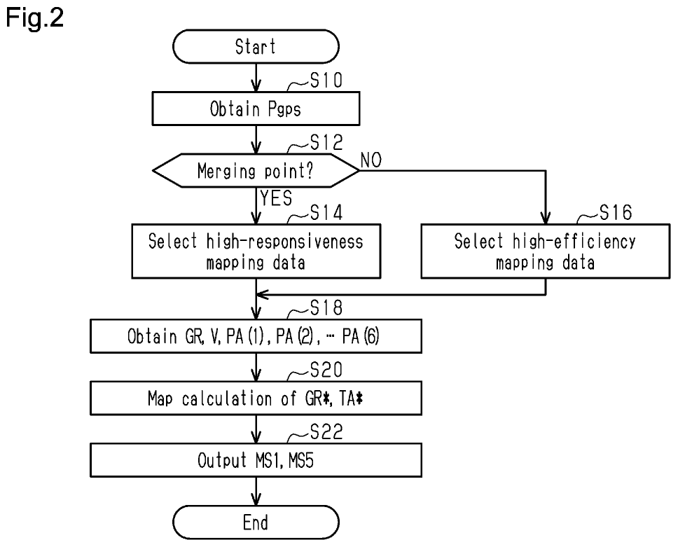

FIG. 2 shows a procedure of processes executed by the controller 70. The process shown in FIG. 2 is implemented by the CPU 72 repeatedly executing programs stored in the ROM 74 at a predetermined interval. In the following description, the number of each step is represented by the letter S followed by a numeral.

In the series of processes shown in FIG. 2, the CPU 72 first acquires positional data Pgps (S10). The CPU 72 then identifies a position on the geographical map shown by the geographical map data DG using the positional data Pgps, and determines whether the identified position corresponds to a merging point at which a general road merges into an expressway (S12). If the position on the geographical map is a merging point (S12: YES), the CPU 72 selects the high-responsiveness mapping data DM1 (S14). If the position on the geographical map is not a merging point (S12: NO), the CPU 72 selects the high-efficiency mapping data DM2 (S16).

When the process of S14 or S16 is completed, the CPU 72 acquires time-series data including six sampled values PA(1), PA(2), . . . PA(6) of the accelerator operation amount PA, the current gear ratio GR, and the vehicle speed V (S18). The sampled values included in the time-series data are sampled at different points in time. In the present embodiment, the time-series data includes six sampled values that are sampled at a constant sampling period and are consecutive in time.

The CPU 72 then uses the map selected in the process of S14 or S16 in order to obtain the throttle command value TA* and the gear ratio command value GR* through map calculation (S20). In map calculation, when the value of an input variable matches any of the values of the input variable on the mapping data, the corresponding value of the output variable on the mapping data is used as the calculation result. In contrast, when the value of an input variable does not match any of the values of the input variable on the mapping data, a value obtained by interpolation of multiple values of the output variable included in the mapping data is used as the calculation result.

The CPU 72 then outputs the operation signal MS1 to the throttle valve 14, thereby controlling the throttle opening degree TA, and outputs the operation signal MS5 to the transmission 50, thereby controlling the gear ratio (S22). In the present embodiment, the throttle opening degree TA is feedback-controlled to the throttle command value TA*. Thus, even if the throttle command value TA* remains the same value, the operation signal MS1 may have different values.

When the process of S22 is completed, the CPU 72 temporarily suspends the series of processes shown in FIG. 2.

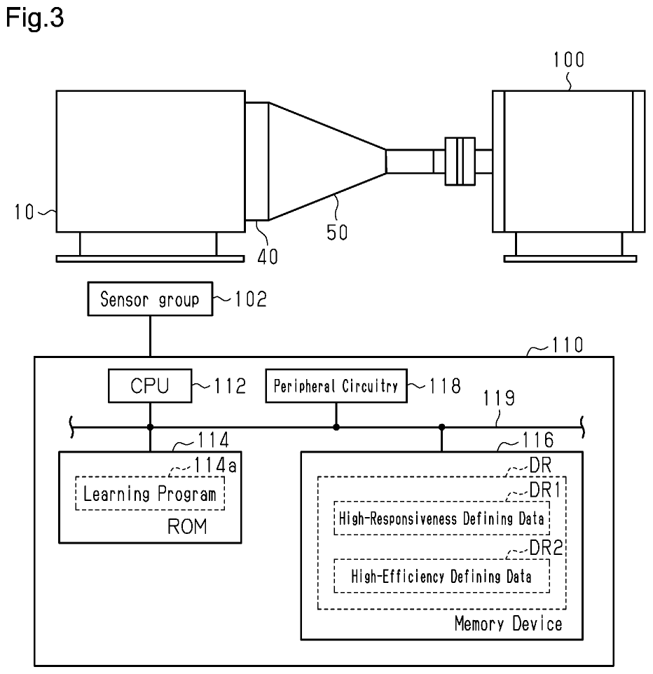

FIG. 3 shows a system that generates the mapping data DM.

As shown in FIG. 3, the crankshaft 28 of the internal combustion engine 10 is mechanically coupled to a dynamometer 100 via the torque converter 40 and the transmission 50. A sensor group 102 detects a variety of state variables during operation of the internal combustion engine 10. The results of the detection are delivered to a generator 110, which is a computer that generates the mapping data DM. The sensor group 102 includes sensors mounted on the vehicle VC1 shown in FIG. 1.

The generator 110 includes a CPU 112, a ROM 114, a nonvolatile memory that can be electrically rewritten (memory device 116), and peripheral circuitry 118. The CPU 112, the ROM 114, the memory device 116, and the peripheral circuitry 118 are connected together through a local network 119 to communicate with one another. The memory device 116 stores relationship-defining data DR. The relationship-defining data DR defines the relationship between a state variable (e.g. the time-series data of the accelerator operation amount PA, the vehicle speed V, and the gear ratio GR) and an action variable (e.g. the throttle command value TA* and the gear ratio command value GR*). The relationship-defining data DR includes high-responsiveness defining data DR1 and high-efficiency defining data DR2. Also, the ROM 114 stores a learning program 114a for learning the relationship-defining data DR through reinforcement learning.

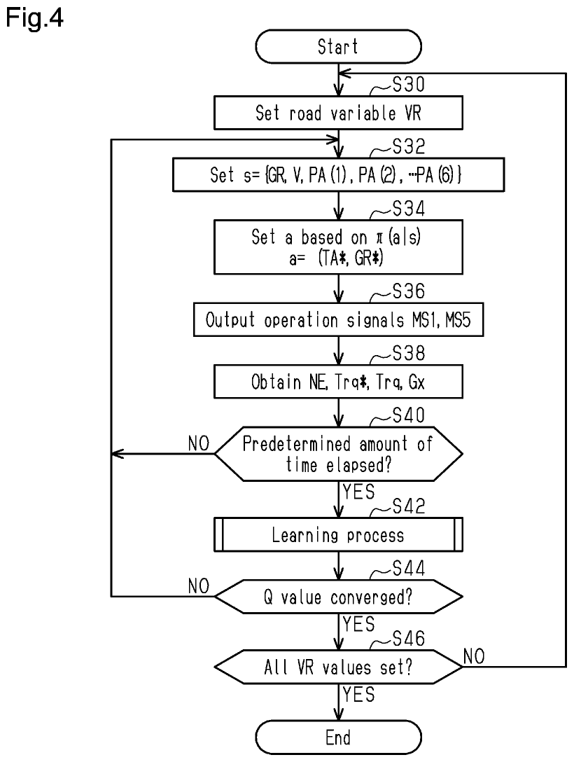

FIG. 4 shows a procedure of processes executed by the generator 110. The processes shown in FIG. 4 are implemented by the CPU 112 executing the learning program 114a stored in the ROM 114.

In the series of processes shown in FIG. 4, the CPU 112 first sets the value of a road variable VR, which indicates whether a position on the geographical map is a merging point (S30). Then, with the internal combustion engine 10 running, the CPU 112 sets, as a state s, the time-series data of the accelerator operation amount PA, the current gear ratio GR, and the vehicle speed V (S32). The time-series data is the same data as in the process of S18. However, the system shown in FIG. 3 does not include the accelerator pedal 86. Thus, the generator 110 virtually generates the accelerator operation amount PA by simulating the state of the vehicle VC1. The virtually generated accelerator operation amount PA is regarded as a state of the vehicle based on a detection value of a sensor. The vehicle speed V is calculated by the CPU 112 as a traveling speed of a vehicle assuming that the vehicle actually exists. The vehicle speed is regarded as a state of the vehicle based on a detection value of a sensor. Specifically, the CPU 112 calculates a rotation speed NE of the crankshaft 28 on the basis of the output signal Scr of the crank angle sensor 84, and calculates the vehicle speed V on the basis of the rotation speed NE and the gear ratio GR.

Next, in accordance with a policy π, the CPU 112 sets an action a, which includes the throttle command value TA* and the gear ratio command value GR* corresponding to the state s obtained through the process of S32 (S34). In this case, the policy π is defined by one of two sets of data (the high-responsiveness defining data DR1 and the high-efficiency defining data DR2) that corresponds to the road variable VR, which has been set in the process of S30.

The relationship-defining data DR is used to define an action value function Q and the policy π. The action value function Q is a table-type function representing values of expected return in accordance with ten-dimensional independent variables of the state s and the action a. When a state s is provided, the action value function Q includes values of the action a at which the independent variables correspond to the provided state s. Among these values, the one at which the expected return is maximized is referred to as a greedy action. The policy π defines rules with which the greedy action is preferentially selected, and an action a different from the greedy action is selected with a predetermined probability.

Specifically, the number of the values of the independent variable of the action value function Q is obtained by reducing, by some amount, all the possible combinations of the state s and the action a, using human knowledge and the like. In time-series data of the accelerator operation amount PA, human operation of the accelerator pedal 86 would never create a situation in which one of two consecutive values is the minimum value of the accelerator operation amount PA and the other is the maximum value. The action value function Q is not defined for such cases. In order to avoid an abrupt change of the gear ratio GR from second gear to fourth gear, the gear ratio command value GR* is limited to first gear, second gear, and third gear, as the action a that can be taken in a case in which the current gear ratio GR is second gear. That is, when the gear ratio GR, which is the state s, is second gear, the action a for fourth or higher gear is not defined. In the first embodiment, reduction of the dimensions on the basis of human knowledge limits the possible values of the independent variable defined by the action value function Q to a number less than or equal to 10 to the fifth power, and preferably, to a number less than or equal to 10 to the fourth power.

Next, as in the process of S22, the CPU 112 outputs the operation signals MS1, MS5 on the basis of the set throttle command value TA* and the gear ratio command value GR* (S36). The CPU 112 obtains the rotation speed NE, the gear ratio GR, torque Trq of the internal combustion engine 10, a torque command value Trq* to the internal combustion engine 10, and the acceleration Gx (S38). The CPU 112 calculates the torque Trq on the basis of the load torque generated by the dynamometer 100 and the gear ratio GR. The torque command value Trq* is set in accordance with the accelerator operation amount PA and the gear ratio GR. The gear ratio command value GR* is an action variable of reinforcement learning. Thus, the gear ratio command value GR* does not necessarily have a value that sets the torque command value Trq* to a value less than or equal to the maximum torque achievable by the internal combustion engine 10. Therefore, the torque command value Trq* is not necessarily a value that is less than or equal to the maximum torque achievable by the internal combustion engine 10. Also, on the basis of the load torque of the dynamometer 100 or the like, the CPU 112 calculates the acceleration Gx as a value that would be produced in the vehicle if the internal combustion engine 10 and the like were mounted on the vehicle. That is, the acceleration Gx, which is a hypothetical value, is regarded as a state of the vehicle based on a detection value of a sensor.

The CPU 72 determines whether a predetermined amount of time has elapsed from the later one of the point in time at which the process of S30 was executed and the point in time at which the process of S42, which will be discussed below, was executed (S40). When determining that the predetermined amount of time has elapsed (S40: YES), the CPU 112 updates the action value function Q through reinforcement learning (S42).

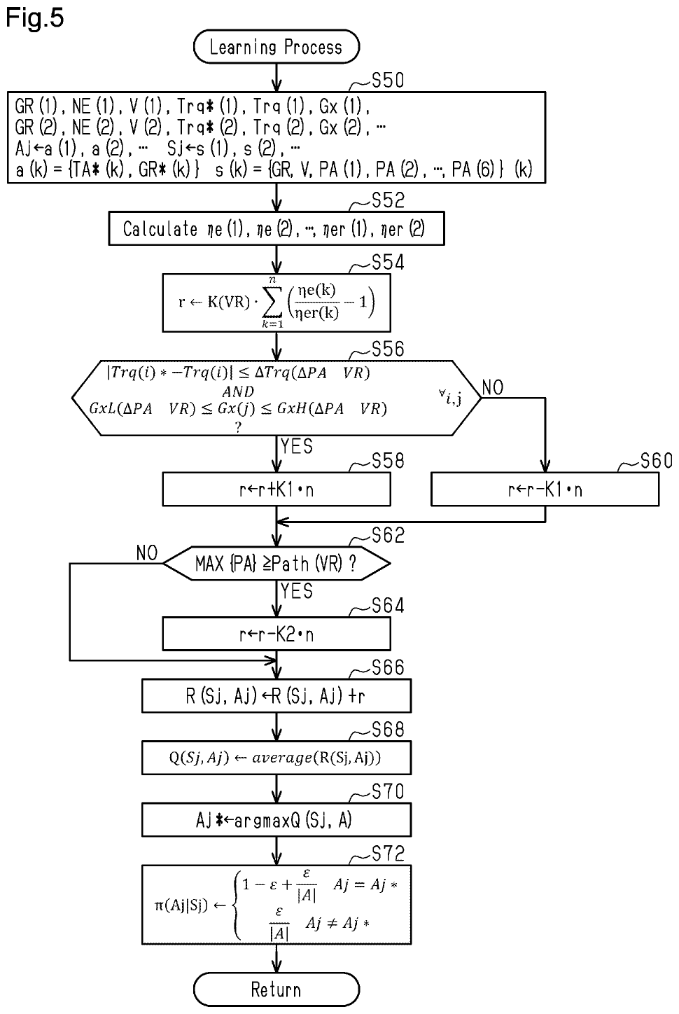

FIG. 5 illustrates the details of the process of S42.

In the series of processes shown in FIG. 5, the CPU 112 acquires time-series data including groups of four sampled values of the rotation speed NE, the torque command value Trq*, the torque Trq, and the acceleration Gx in a predetermined period, and time-series data of the state s and the action a (S50). In FIG. 5, variables of which the numbers in parentheses are different are variables at different sampling points in time. A torque command value Trq*(1) and a torque command value Trq*(2) are sampled at different sampling points in time. The time-series data of the action a in the predetermined period is defined as an action set Aj, and the time-series data of the state s in the predetermined period is defined as a state set Sj.

Next, on the basis of the time-series data of the torque Trq and the rotation speed NE, the CPU 112 calculates time-series data of efficiency ηe of the internal combustion engine 10 and time-series data of a reference efficiency ηer (S52). Specifically, while setting k to subsequent numbers starting from 1 (k=1, 2, 3), the CPU 112 calculates the efficiency ηe(k) of the internal combustion engine 10 and the reference efficiency ηer(k) on the basis of an operating point defined by the torque Trq(k) and the rotation speed NE(k). The efficiency ηe is defined for each operating point of the internal combustion engine 10 and indicates the ratio of thermal energy that can be extracted as driving force when the thermal energy is Generated with the air-fuel ratio of the air-fuel mixture in the combustion chamber 24 set to a predetermined value, and with the ignition timing set to a predetermined timing. Also, the reference efficiency ηer is defined for each value of the output of the internal combustion engine 10 and is obtained by multiplying, by a predetermined coefficient less than 1, the maximum value of the ratio of thermal energy that can be extracted as driving force when the thermal energy is generated with the air-fuel ratio of the air-fuel mixture in the combustion chamber 24 set to a predetermined value, and with the ignition timing set to a predetermined timing. That is, the reference efficiency ηer is obtained by multiplying, by the predetermined coefficient, the ratio of thermal energy that can be extracted as driving force at an operating point at which that ratio is maximized. The CPU 72 obtains the efficiency ηe through map calculation in a state in which the ROM 74 stores mapping data having the torque Trq and the rotation speed NE as input variables and the efficiency ηe as an output variable. Further, the CPU 72 obtains the reference efficiency Tier through map calculation in a state in which the ROM 74 stores mapping data that has the product of the torque Trq and the rotation speed NE as an input variable, and the reference efficiency Tier as an output variable.

Next, the CPU 112 divides the efficiency ηe(k) by the reference efficiency ηer(k) and subtracts 1 from the quotient. The CPU 112 then multiplies the integrated value of the difference by a coefficient K, and assigns the product to a reward r (S54). This process causes the reward r to have a larger value, when the efficiency ηe is higher than the reference efficiency ηer, than when the efficiency ηe is lower than the reference efficiency ηer.

The CPU 112 varies the coefficient K in accordance with the road variable VR. Specifically, the coefficient K is set to a larger value, when the road variable VR does not indicate a merging point than, when the road variable VR indicates a merging point. This setting causes the standard for providing a predetermined reward to be low when the position on the geographical map is not a merging point. That is, even if the same reward is provided, the efficiency ηe is low if the position is not a merging point. Accordingly, if an operating point at which the high-efficiency ηe is high is selected, the reward r is set to a larger value, when the position is not a merging point, than when the position is a merging point.

Next, the CPU 112 determines whether the logical conjunction of the following conditions (a) and (b) is true: the condition (a) is that the absolute value of the difference between an arbitrary torque Trq in a predetermined period and the torque command value Trq* is less than or equal to a specified amount ΔTrq; and the condition (b) is that the acceleration Gx is greater than or equal to a lower limit G×L and less than or equal to an upper limit G×H (S56).

The CPU 112 varies the specified amount ΔTrq depending on a change amount per unit time ΔPA of the accelerator operation amount PA and the value of the road variable VR at the start of an episode. That is, the CPU 112 determines that the episode is related to transient time if the absolute value of the change amount ΔPA is large and sets the specified amount ΔTrq to a larger value than in a case in which the episode related to steady time. Also, the CPU 112 sets the specified amount ΔTrq to a larger value, when the position is not a merging point, than when the position is a merging point.

The CPU 112 varies the lower limit G×L depending on the change amount ΔPA of the accelerator operation amount PA at the start of the episode. That is, when the episode is related to transient time and the change amount ΔPA has a positive value, the CPU 112 sets the lower limit G×L to a larger value than in a case in which the episode is related to steady time. When the episode is related to transient time and the change amount ΔPA has a negative value, the CPU 112 sets the lower limit G×L to a lower value than in a case in which the episode is related to steady time.

Also, the CPU 72 varies the upper limit G×H depending on the change amount per unit time ΔPA of the accelerator operation amount PA at the start of the episode. That is, when the episode is related to transient time and the change amount ΔPA has a positive value, the CPU 72 sets the upper limit G×H to a larger value than in a case in which the episode is related to steady time. When the episode is related to transient time and the change amount ΔPA has a negative value, the CPU 72 sets the upper limit G×H to a lower value than in a case in which the episode is related to steady time.

The CPU 112 also varies the lower limit G×L and the upper limit G×H depending on the road variable VR. Specifically, the CPU 112 sets the lower limit G×L and the upper limit G×H such that the absolute value of the acceleration Gx at transient time is larger when the position is a merging point than when the position is not a merging point.

When determining that the logical conjunction of the condition (a) and the condition (b) is true (S56: YES), the CPU 72 adds K1·n to the reward r (S58). When determining that the logical conjunction of the condition (a) and the condition (b) is false (S56: NO), the CPU 72 subtracts K1·n from the reward r (S60). The symbol n represents the number of times the efficiency ηe is sampled in a predetermined period. The processes from S56 to S60 are designed to provide a greater reward when a standard related to acceleration response is met than when the standard is not met.

When the process of S58 or S60 is completed, the CPU 112 determines whether a condition (c) is met, the condition (c) being that the maximum value of the accelerator operation amount PA in a predetermined period is greater than or equal to a threshold PAth (S62). The CPU 112 sets the threshold PAth to a larger value, when the position is not a merging point, than when the position is a merging point. When the condition (c) is met (S62: YES), the CPU 112 subtracts K2 n from the reward r (S64). That is, since the user may be experiencing torque insufficiency when the accelerator operation amount PA is excessively large, a negative reward is provided in order to impose a penalty.

When the process of S64 is completed or when the determination is negative in the process of S62, the CPU 112 updates the relationship-defining data DR stored in the memory device 76 shown in FIG. 3. In the present embodiment, the ε-soft on-policy Monte Carlo method is used.

The CPU 112 adds the reward r to respective returns R(Sj, Aj), which are determined by combinations of the states obtained through the process of S50 and actions corresponding to the respective states (S66). “R(Sj, Aj)” collectively represents the returns R each having one of the elements of the state set Sj as the state and one of the elements of the action set Aj as the action. Next, the CPU 112 averages each of the returns R(Sj, Aj), which are determined by combinations of the states and the corresponding actions obtained through the process of S50, and assigns the averaged values to the corresponding action value functions Q(Sj, Aj) (S68). The averaging process simply needs to be a process of dividing the return R, which is calculated through the process of S68, by the number of times the process S68 has been executed. The initial value of the return R simply needs to be set to zero.

Next, for each of the states obtained through the process of S50, the CPU 112 assigns, to an action Aj*, an action that is the combination of the throttle command value TA* and the gear ratio command value GR* in the corresponding action value function Q(Sj, A) at the time when the action value function Q is maximized (S70). The variable A represents an arbitrary action that can be taken. The action Aj* can have different values depending on the type of the state obtained through the process of S50. However, in view of simplification, the action Aj* has the same symbol regardless of the type of the state in the present description.

Next, the CPU 112 updates a policy π(Aj|Sj) corresponding to each of the states obtained through the process of S50 (S72). That is, the CPU 112 sets the selection probability of the action Aj* selected through S72 to (1−ε)+ε/|A|, where |A| represents the total number of actions. The number of the actions other than the action Aj* is represented by |A|−1. The CPU 112 sets the selection probability of each of the actions other than the action Aj* to ε/|A|. The process of S72 is based on the action value function Q, which has been updated through the process of S68. Accordingly, the relationship-defining data DR, which defines the relationship between the state s and the action a, is updated to increase the return R.

When the process of step S72 is completed, the CPU 112 temporarily suspends the series of processes shown in FIG. 5.

Referring back to FIG. 4, when the process of S42 is completed, the CPU 112 determines whether the action value function Q has converged (S44). The CPU 112 simply needs to determine that the action value function Q has converged when the number of consecutive times the updated amount of the action value function Q in the process of S42 is less than or equal to a predetermined value has reached a predetermined number of times. When the action value function Q has not converged (S44: NO) or when a negative determination is made in the process of S40, the CPU 112 returns to the process of S32. If the action value function Q has conversed (S44: YES), the CPU 112 determines whether an affirmative determination has been made in the process of S44 for both of a merging point and a position other than a merging point (S46).

If the determination is not affirmative in the process of S44 for either a merging point or a position other than a merging point (S46: NO), the CPU 112 returns to S30 and substitutes a value that has not been set into the road variable VR. When the determination is affirmative in the process of S46, the CPU 112 temporarily suspends the series of processes shown in FIG. 4.

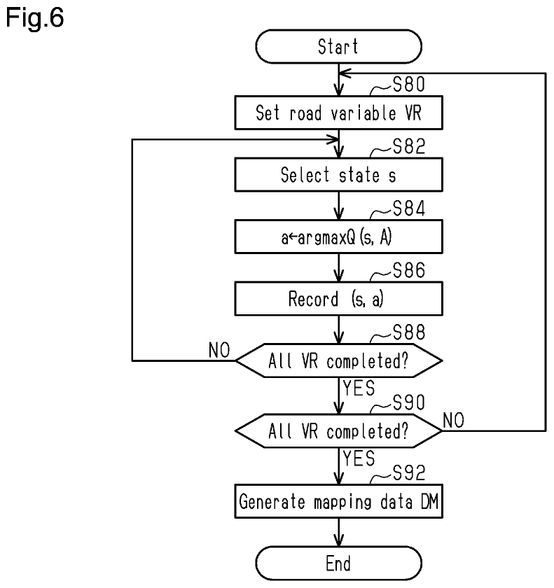

The processes executed by the generator 110 include the one shown in FIG. 6. Specifically, FIG. 6 shows a procedure of processes executed by the generator 110 to generate the mapping data DM on the basis of the action value function Q, which is learned particularly in the process of FIG. 4. The processes shown in FIG. 6 are implemented by the CPU 112 executing the learning program 114a stored in the ROM 114.

In the series of processes shown in FIG. 6, the CPU 112 first sets the value of the road variable VR (S80). Then, the CPU 112 selects one of the states s, which are input variables of the mapping data DM (S82). Next, regarding the action value function Q(s, A) that corresponds to the state s that is defined by one of the two sets of data (the high-responsiveness defining data DR1 and the high-efficiency defining data DR2) that corresponds to the value of the road variable VR, which has been set in the process of S80, the CPU 112 selects the action a that maximizes the value of the action value function Q (S84). That is, the CPU 112 selects the action a through a greedy policy. The CPU 112 stores the combination of the state s and the action a in the memory device 116 (S86).

Next, the CPU 112 determines whether all the values of the input variables of the mapping data DM have been selected in the process of S82 (S88). When there are values of the input variables of the mapping data DM that have not been selected (S88: NO), the CPU 112 returns to the process of S82. If all the values of the input variables of the mapping data DM have been selected (S88: YES), the CPU 112 determines whether all the possible values of the road variable VR in the process of S80 have been set (S90). If there are values that have not been set as values of the road variable VR (S90: NO), the CPU 112 returns to the process of S80 and sets those values.

If all the values have been set as the values of the road variable VR (S90: YES), the CPU 112 generates the high-responsiveness mapping data DM1 and the high-efficiency mapping data DM2 (S92). The value of an output variable that corresponds to the input variable of the mapping data DM the value of which is the state s is defined as a corresponding action a.

When the process of step S92 is completed, the CPU 112 temporarily suspends the series of processes shown in FIG. 6.

An operation and advantages of the present embodiment will now be described.

In the system shown in FIG. 3, the CPU 112 learns the action value function Q through reinforcement learning. When the value of the action value function Q converges, the CPU 112 assumes that an appropriate action has been learned to meet the standard required for energy use efficiency and the standard required for acceleration response. Then, for each of the states that are the input variables of the mapping data DM, the CPU 112 selects an action that maximizes the action value function Q and stores the combinations of the states and the actions in the memory device 116. Next, the CPU 112 generates the mapping data DM on the basis of the combinations of the states and actions stored in the memory device 116. Thus, the appropriate throttle command value TA* and gear ratio command value GR* that correspond to the accelerator operation amount PA, the vehicle speed V, and the gear ratio GR can be set without excessively increasing the man-hours by skilled workers.

Particularly, in the first embodiment, different actions a are learned for each of the states s in correspondence with whether the position on the geographical map is a merging point. Specifically, the standard for the acceleration response is relaxed for positions that are not a merging point. Also, the reward is provided such that a higher value of the efficiency ηe is more advantageous. Accordingly, when the high-efficiency defining data DR2 is learned, the reward by the process of S58 can be obtained if the condition (a) and the condition (b) are met even when the acceleration response is relatively low. Also, increasing the efficiency ηe as much as possible is advantageous in increasing the total reward. The high-efficiency mapping data DM2 allows for control that increases the energy use efficiency.

On the other hand, when the high-responsiveness defining data DR1 is learned, the reward obtained in the process of S54 is small despite an increase in the efficiency ηe. This configuration is advantageous since, in order to increase the total reward, the reward of the process of S58 can be obtained if meeting the condition (a) and the condition (b) are met. Therefore, the high-responsiveness mapping data DM1 allows for control that improves the responsiveness to operation of the accelerator by the user.

The first embodiment further has the following operation and advantages.

(1) The memory device 76 of the controller 70 stores the mapping data DM, not the action value function Q. This allows the CPU 72 to set the throttle command value TA* and the gear ratio command value GR* on the basis of map calculation using the mapping data DM. This configuration reduces the computation load as compared to a case in which a process for selecting the maximum value of the action value function Q is executed.

(2) The independent variables of the action value function Q include time-series data of the accelerator operation amount PA. The value of the action a thus can be finely adjusted in response to various changes in the accelerator operation amount PA, as compared to a case in which a single sampled value is used as the independent variable regarding the accelerator operation amount PA.

(3) The independent variables of the action value function Q include the throttle command value TA*. This increases the degree of flexibility of the search performed by reinforcement learning as compared to a case in which a parameter of a model equation that models the behavior of the throttle command value TA* is used as an independent variable related to the throttle opening degree.

### Second Embodiment

A second embodiment will now be described with reference to the drawings. The differences from the first embodiment will mainly be discussed.

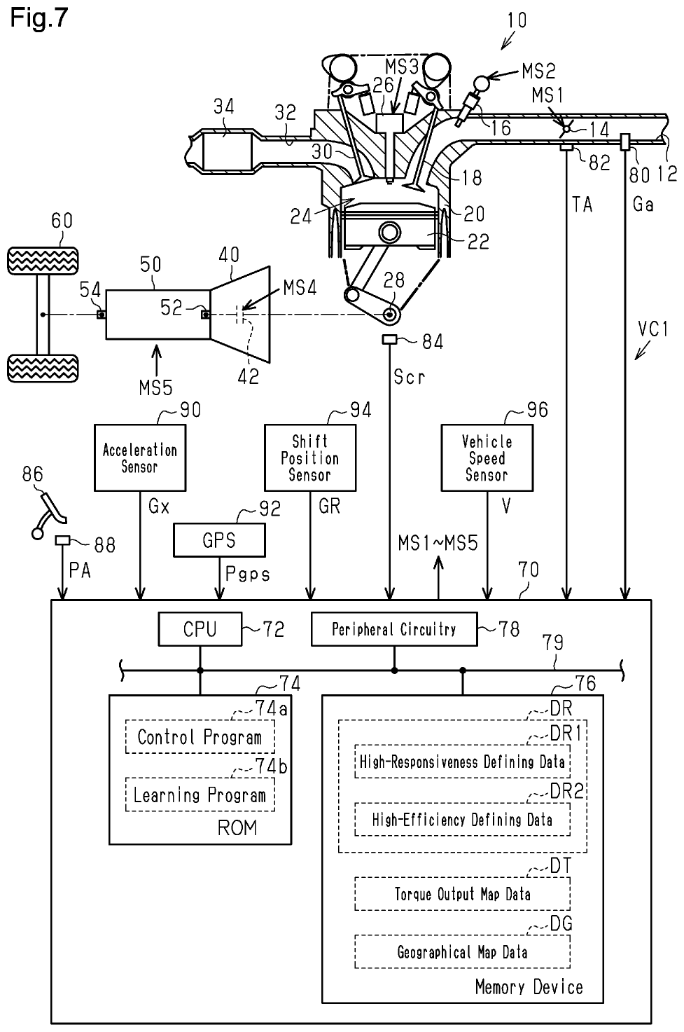

FIG. 7 shows a drive system of a vehicle VC1 and a controller according to the second embodiment. In FIG. 7, the same reference numerals are given to the components that are the same as those in FIG. 1.

As shown in FIG. 7, the ROM 74 of the second embodiment stores a learning program 74b in addition to the control program 74a. The memory device 76 does not store the mapping data DM. Instead, the memory device 76 stores relationship-defining data DR and torque output map data DT. The relationship-defining data DR is learned data, which is data that has been learned through the process of FIG. 4. The relationship-defining data DR uses, as the states s, the time-series data of the accelerator operation amount PA, the vehicle speed V, and the gear ratio GR, and uses, as the actions a, the throttle command value TA* and the gear ratio command value GR*. The relationship-defining data DR includes high-responsiveness defining data DR1 and high-efficiency defining data DR2. The torque output map data DT defines a torque output map. The torque output map is data related to a learned model, such as a neural network, which uses, as inputs, the rotation speed NE, a charging efficiency and the ignition timing, and outputs the torque Trq. For example, the torque output map data DT simply needs to be learned using, as teaching data, the torque Trq, which is obtained through the process of S38 during execution of the processes of FIG. 4. The charging efficiency η simply needs to be calculated by the CPU 72 on the basis of the rotation speed NE and the intake air amount Ga.

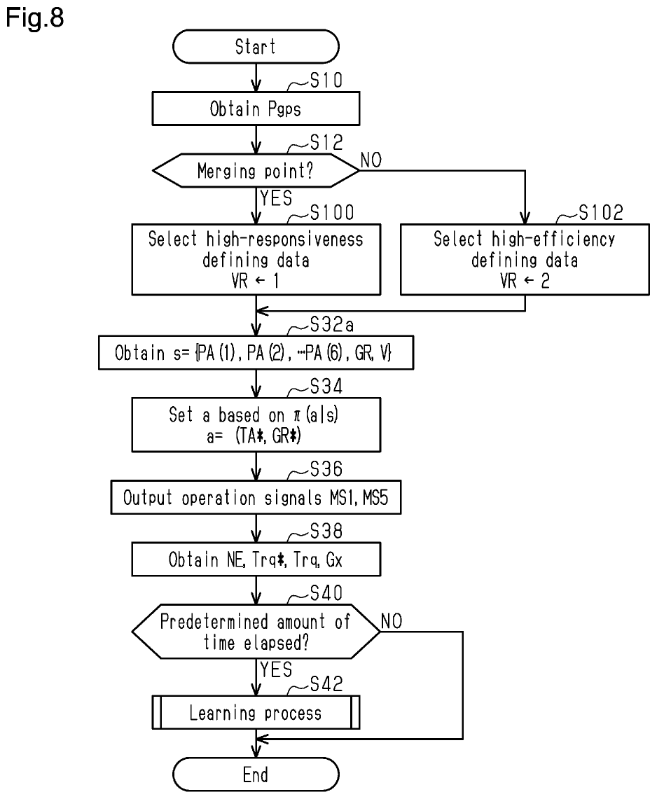

FIG. 8 shows a procedure of processes executed by a controller 70 according to the second embodiment. The processes shown in FIG. 8 are implemented by the CPU 72 repeatedly executing the control program 74a and the learning program 74b stored in the ROM 74 at predetermined intervals. In FIG. 8, the same step numbers are given to the processes that correspond to those in FIG. 4.

In the series of processes shown in FIG. 8, the CPU 72 first executes the processes of S10, S12 of FIG. 2. If the position on the geographical map is a merging point (S12: YES), the CPU 72 assigns 1 to the road variable VR and selects the high-responsiveness defining data DR1 (S100). If the position on the geographical map is not a merging point (S12: NO), the CPU 72 assigns 2 to the road variable VR and selects the high-efficiency defining data DR2 (S102). When the process of S100 or S102 is completed, the CPU 112 obtains, as the state s, the time-series data of the accelerator operation amount PA, the current gear ratio GR, and the vehicle speed V (S32a). Thereafter, the CPU 112 executes the processes of S34 to S42 in FIG. 4. When the determination is negative in the process of S40 or when the process of S42 is completed, the CPU 72 temporarily suspends the series of processes shown in FIG. 8. The processes of S10, S12, S100, S102, S32a, and S34 to S40 are implemented by the CPU 72 executing the control program 74a. The process of S42 is implemented by the CPU 72 executing the learning program 74b.

As described above, the controller 70 is provided with the relationship-defining data DR and the learning program 74b in the second embodiment. This increases the learning frequency as compared to the case of the first embodiment.

### Third Embodiment

A third embodiment will now be described with reference to the drawings. The differences from the second embodiment will mainly be discussed.

In the third embodiment, the relationship-defining data DR is updated outside the vehicle VC1.

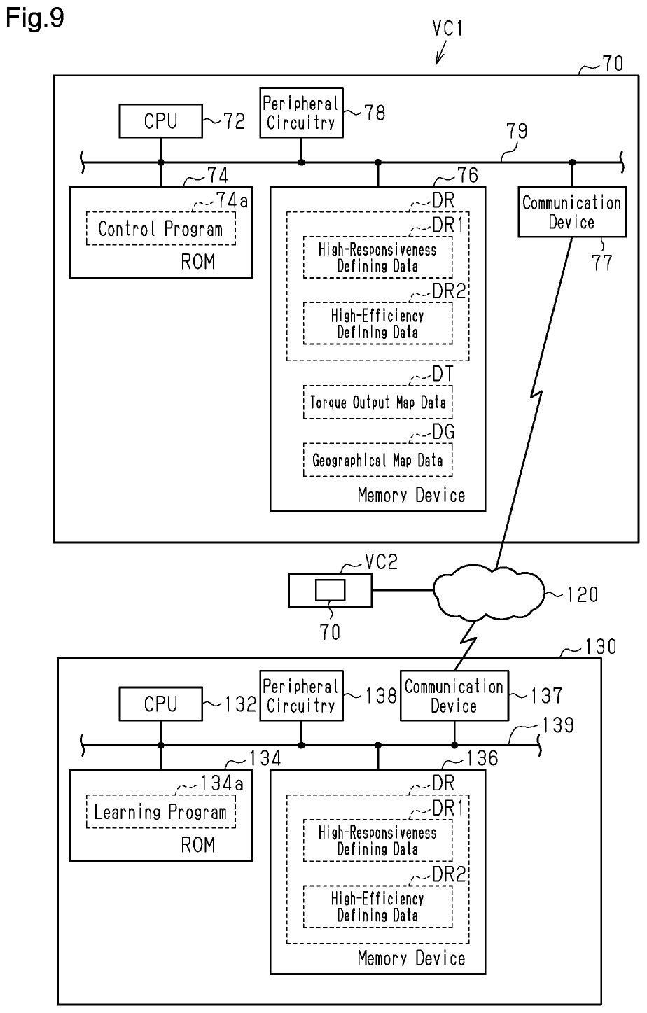

FIG. 9 shows the configuration of a control system according to the third embodiment that performs reinforcement learning. In FIG. 9, the same reference numerals are given to the components that correspond to those shown in FIG. 1.

The ROM 74 of the controller 70 in the vehicle VC1 shown in FIG. 9 stores the control program 74a, but does not store the learning program 74b. The controller 70 includes a communication device 77. The communication device 77 communicates with a data analysis center 130 via a network 120 outside the vehicle VC1.

The data analysis center 130 analyzes data transmitted from vehicles VC1, VC2, . . . . The data analysis center 130 includes a CPU 132, a ROM 134, a nonvolatile memory that can be electrically rewritten (memory device 136), peripheral circuitry 138, and a communication device 137. The CPU 132, the ROM 134, the memory device 136, and the peripheral circuitry 138 are connected together through a local network 139 to communicate with one another. The ROM 134 stores a learning program 134a. The memory device 136 stores relationship-defining data DR.

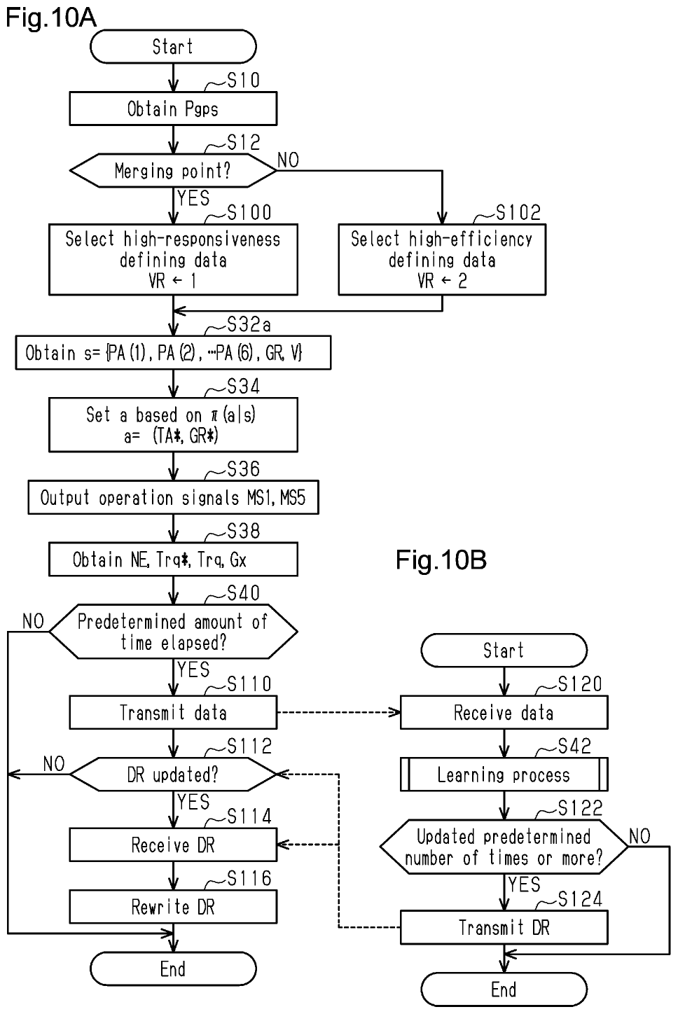

FIGS. 10A and 10B show a procedure of processes of reinforcement learning according to the third embodiment. The processes shown in FIG. 10A are implemented by the CPU 72 executing the control program 74a stored in the ROM 74 shown in FIG. 9. The processes shown in FIG. 10B are implemented by the CPU 132 executing the learning program 134a stored in the ROM 134. In FIGS. 10A and 10B, the same step numbers are given to the processes that correspond to those in FIG. 8. The processes shown in FIGS. 10A and 10B will now be described with reference to the temporal sequence of the reinforcement learning.

In the series of processes shown in FIG. 10A, the CPU 72 first executes the processes of S10, S12, S100, S102, S32a, and S34 to S38. When a predetermined amount of time has elapsed (S40: YES), the CPU 72 operates the communication device 77 to transmit data necessary for the update process of the relationship-defining data DR (S110). The data to be transmitted includes the values of the road variable VR in the predetermined amount of time, the rotation speed NE, the torque command value Trq*, the time-series data of the torque Trq and the acceleration Gx, the state set Sj, and the action set Aj.

As shown in FIG. 10B, the CPU 132 receives the transmitted data (S120), and updates the relationship-defining data DR on the basis of the received data (S42). The CPU 132 determines whether the number of times the relationship-defining data DR has been updated is greater than or equal to a predetermined number of times (S122). When determining that the number of times of update is greater than or equal to the predetermined number of times (S122: YES), the CPU 132 operates the communication device 137 to transmit the relationship-defining data DR to the vehicle VC1, which transmitted the data that was received through the process of S120 (S124). When the process of S124 is completed or when the determination is negative in the process of S122, the CPU 132 temporarily suspends the series of processes shown in FIG. 10B.

As shown in FIG. 10A, the CPU 72 determines whether there is update data (S112). When there is update data (S112: YES), the CPU 72 receives the updated relationship-defining data DR (S114). Then, the CPU 72 rewrites the relationship-defining data DR used in the process of S34 with the received relationship-defining data DR (S116). When the process of S116 is completed or when the determination is negative in the process of S40 or S112, the CPU 72 temporarily suspends the series of processes shown in FIG. 10A.

As described above, the relationship-defining data DR is updated outside the vehicle VC1. This reduces the computation load on the controller 70. Further, if the process of S42 is executed by receiving data from multiple vehicles VC1, VC2 in the process of S120, the number of data sets used for learning can be increased easily.

<Correspondence>

The correspondence between the items in the above-described embodiments and the items the WHAT IS CLAIMED IS section is as follows. Below, the correspondence is shown for each claim number.

[1, 2] The execution device and the memory device correspond to the CPU 72 and the set of the ROM 74 and the memory device 76 in FIG. 7, respectively, to the CPU 112 and the set of the ROM 114 and the memory device 116 in FIG. 3, respectively, and to the CPUs 72, 132 and the set of the ROMs 74, 134 and the memory devices 76, 136 in FIG. 9, respectively. The obtaining process corresponds to the processes of S30, S32, S38 of FIG. 4 and the processes of S10, S12, S100, S102, S32a, S38 of FIGS. 8 and 10. The operation process corresponds to the process of S36, the reward calculating process corresponds to the processes of S52 to S64, and the update process corresponds to the processes of S66 to S72. The update map corresponds to the map defined by the command that executes the processes of S66 to S72 in the learning program 74b. The changing process corresponds to varying the coefficient K in correspondence with the road variable VR in the process of S54, varying the condition (a) and the condition (b) in correspondence with the road variable VR in the process of S56, and varying the threshold PAth in correspondence with thee road variable VR in the process of S62.

[3] The control map data corresponds to the mapping data DM.

[4] The execution device and the memory device correspond to the CPU 72 and the set of the ROM 74 and the memory device 76 in FIG. 7, respectively.

[5-7] The first execution device corresponds to the CPU 72 and the ROM 74, and the second execution device corresponds to the CPU 132 and the ROM 134.

### Other Embodiments

The above-described embodiments may be modified as follows. The above-described embodiments and the following modifications can be combined as long as the combined modifications remain technically consistent with each other.

Regarding Road Variable

The road variable, which represents information related to the road on which the vehicle is traveling, is not limited to a variable that indicates whether a position on a geographical map is a merging point. The road variable may be a variable that indicates whether a position on a geographical map is on a general road or an expressway. Alternatively, the road variable may be a variable that indicates information related to the gradient of a road or information related to the curvature of a road.

Regarding Changing Process

In the process of S56, the conditions (a) and (b) are varied depending on whether the position is a merging point. However, the present disclosure is not limited to this. The coefficient K1 in the processes of S58, S60 may be varied depending on whether the position is a merging point. That is, if the coefficient K1 is reduced when the position is not a merging point, meeting the condition (a) and the condition (b) will not be significantly advantageous for increasing the total reward. Accordingly, learning for increasing the efficiency ηe is likely to be performed.

In the process of S62, the threshold PAth is varied depending on whether the position is a merging point. However, the present disclosure is not limited to this. The coefficient K2 in the process of S64 may be varied depending on whether the position is a merging point. That is, if the coefficient K2 is reduced when the position is not a merging point, a negative determination in the process of S62 will not be significantly advantageous for increasing the total reward. Accordingly, learning for increasing the efficiency ηe is likely to be performed.

In the above-described embodiments, either one of the following processes is executed: the process that changes the standard for the acceleration response in S56 or S62; and the process that changes the reward that corresponds to whether the standard for the acceleration response is met. However, these two processes may both be executed.

In the above-described configurations, the coefficient K is reduced, and the conditions (a) to (c) are made strict. However, the present disclosure is not limited to this. Only the reduction of the coefficient K may be performed. In this case, it would be no longer beneficial to increase the efficiency ηe in order to increase the reward. Thus, the action that improves the acceleration response is likely to become a greedy action.

A configuration may be employed in which: when the position is not a merging point, the condition (a) and the condition (b) are changed to conditions that cannot be met, and the process of S60 adds 0 to the reward r; and when the position is a merging point, the reference efficiency ηer in the process of S54 is made a high-efficiency that cannot be reached, and the greater one of the integrated value and zero is assigned to the reward r. This configuration is equivalent to a configuration in which: in a case in which the position is not a merging point, a process is not executed that provides a greater reward when the acceleration response meets a standard than when the acceleration response does not meet the standard; and in a case in which the position is a merging point, a process is not executed that provides a greater reward when the energy use efficiency meets a standard than when the energy use efficiency does not meet the standard. Therefore, it is possible to employ the configuration in which: in a case in which the position is not a merging point, a process is not executed that provides a greater reward when the acceleration response meets a standard than when the acceleration response does not meet the standard; and in a case in which the position is a merging point, a process is not executed that provides a greater reward when the energy use efficiency meets a standard than when the energy use efficiency does not meet the standard. This configuration can be regarded as a configuration including a process that changes at least one of the process that provides a greater reward when the acceleration response meets a standard than when the acceleration response does not meet the standard, and a process that provides a greater reward when the energy use efficiency meets a standard than when the energy use efficiency does not meet the standard.

In a case in which the road variable is used to identify whether the road is a general road or an expressway as described in the Regarding Road Variable section, a reward structure may be employed in which: in a case in which the road is an expressway, a reward is used that prioritizes requirements for the acceleration response; and in a case in which the road is a general road, a reward is used that prioritizes requirements for the energy use efficiency. The relationship-defining data DR that is learned in this manner allows for smooth overtaking on an expressway, and increases the energy use efficiency on a general road.

In a case in which the road variable is used to indicate information related to the gradient of a road as described in the Regarding Road Variable section, a reward structure may be employed in which: in a case in which the vehicle is on a slope, a reward is used that prioritizes requirements for the acceleration response; and in a case in which the vehicle is not on a slope, a reward is used that prioritizes requirements for the energy use efficiency. The relationship-defining data DR that is learned in this manner allows torque required by the user to be quickly generated on a slope, and increases the energy use efficiency on a road that is not a slope.

As the changing process that changes the standard that is used when a predetermined reward is provided in correspondence with the road variable, a process is employed that changes one of multiple requirements that is advantageous for providing the predetermined reward. However, the present disclosure is not limited to this. In a case in which the road variable is used to indicate information related to the gradient of a road as described in the Regarding Road Variable section, the torque command value Trq* may be given a larger value on a slope than on a road that is not a slope. The relationship-defining data DR that is learned in this manner allows for control that achieves the same acceleration feel either on a slope or a flat road, through operation of the accelerator.

Regarding Energy Use Efficiency

In the above-described embodiments, the energy use efficiency is quantified on the basis of only an operating point. However, the present disclosure is not limited to this. In a case in which the ignition timing is included in the action variables as described in the Regarding Action Variable section below, if the employed ignition timing is displaced from the minimum advance for best torque (MBT), the energy use efficiency simply needs to be reduced in accordance with the amount of displacement. In a case in which the air-fuel ratio control is included in the action variables, if the employed air-fuel ratio is displaced from a predetermined air-fuel ratio, the energy use efficiency may be corrected in accordance with the amount of displacement.

Regarding Reduction of Dimensions of Table-Type Data

The method of reducing the dimensions of table-type data is not limited to the one in the above-described embodiments. The accelerator operation amount PA rarely reaches the maximum value. Accordingly, the action value function Q does not necessarily need to be defined for the state in which the accelerator operation amount PA is greater than or equal to the specified amount, and it is possible to adapt the throttle command value TA* and the like independently when the accelerator operation amount PA is greater than or equal to the specified value. The dimensions may be reduced by removing, from possible values of the action, values at which the throttle command value TA* is greater than or equal to the specified value.

Regarding Relationship-Defining Data

In the above-described embodiments, the action value function Q is a table-type function. However, the present disclosure is not limited to this. Instead, a function approximator may be used.

Instead of using the action value function Q, the policy π may be expressed by a function approximator that uses the state s and the action a as independent variables and uses, as a dependent variable, the probability that the action a will be taken. In this case, parameters defining the function approximator may be updated in accordance with the reward r. In this case, a function approximator may be provided for each of the values of the road variable VR. Alternatively, the road variable VR may be included in the state s that is an independent variable of a single function approximator.

Regarding Operation Process

When using a function approximator as the action value function Q as described in the Regarding Relationship-Defining Data section, all the combinations of discrete values related to actions that are independent variables of the table-type function in the above-described embodiments simply need to be input to the action value function Q together with the state s, so as to identify the action a that maximizes the action value function Q. In this case, while mainly using the identified action a in the operation, another action simply needs to be selected with a predetermined probability.

When the policy π is a function approximator that uses the state s and the action a as independent variables, and uses the probability that the action a will be taken as a dependent variable as in the Regarding Relationship-Defining Data section, the action a simply needs to be selected on the basis of the probability indicated by the policy 71

Regarding Update Map

The ε-soft on-policy Monte Carlo method is executed in the process of S66 to S72. However, the present disclosure is not limited to this. For example, an off-policy Monte Carlo method may be used. Also, methods other than Monte Carlo methods may be used. For example, an off-policy TD method may be used. An on-policy TD method such as a SARSA method may be used. Alternatively, an eligibility trace method may be used as an on-policy learning.

When the policy π is expressed using a function approximator, and the function approximator is directly updated on the basis of the reward r as in the Regarding Relationship-Defining Data section, the update map simply needs to be constructed using, for example, a policy gradient method.

The present disclosure is not limited to the configuration in which only one of the action value function Q and the policy π is directly updated using the reward r. For example, the action value function Q and the policy it may be separately updated as in an actor critic method. Alternatively, in an actor critic method, a value function V may be updated in place of the action value function Q.

Regarding Action Variable

In the above-described embodiments, the throttle command value TA* is used as an example of the variable related to the opening degree of a throttle valve, which is an action variable. However, the present disclosure is not limited to this. The responsivity of the throttle command value TA* to the accelerator operation amount PA may be expressed by dead time and a secondary delay filter, and three variables, which are the dead time and two variables defining the secondary delay filter, may be used as variables related to the opening degree of the throttle valve. In this case, the state variable is preferably the amount of change per unit time of the accelerator operation amount PA instead of the time-series data of the accelerator operation amount PA.

In the above-described embodiments, a variable related to the opening degree of the throttle valve and a variable related to the gear ratio are used as examples of action variables. However, the present disclosure is not limited to this. In addition to a variable related to the opening degree of the throttle valve and a variable related to the gear ratio, a variable related to the ignition timing and a variable related to the air-fuel ratio control may be used.

As described in the Regarding Internal Combustion Engine section, in the case of a compression ignition internal combustion engine, a variable related to the injection amount simply needs to be used in place of the variable related to the opening degree of the throttle valve. In addition to this, it is possible to use a variable related to the injection timing, a variable related to the number of times of injection within a single combustion cycle, and a variable related to the time interval between the ending point in time of one fuel injection and the starting point in time of the subsequent fuel injection for a single cylinder within a single combustion cycle.

In a case in which the transmission 50 is a multi-speed transmission, the action variable may be the value of the current supplied to the solenoid valve that adjusts the engagement of the clutch using hydraulic pressure.

In a case in which objects of operation in accordance with the action variable includes a rotating electric machine as described in the Regarding Electronic Devices section, the action variable simply needs to include the torque and the current of the rotating electric machine. That is, the load variable, which is a variable related to the load on the propelling force generator, is not limited to the opening degree of the throttle valve or the injection amount. The load variable may be the torque or the current of the rotating electric machine.

In a case in which objects of operation in accordance with an action variable include a lockup clutch 42 as described in the Regarding Electronic Devices section, the action variable simply needs to include the engagement state of the lockup clutch 42.

Regarding State

In the above-described embodiments, the time-series data of the accelerator operation amount PA includes six values that are sampled at equal intervals. However, the present disclosure is not limited to this. The time-series data of the accelerator operation amount PA may be any data that includes two or more values sampled at different sampling points in time. It is preferable to use data that includes three or more sampled values or data of which the sampling interval is constant.

The state variable related to the accelerator operation amount is not limited to the time-series data of the accelerator operation amount PA. For example, as described in the Regarding Action Variable section, the amount of change per unit time of the accelerator operation amount PA may be used.

For example, when the current value of the solenoid valve is used as the action variable as described in the Regarding Action Variable section, the state simply needs to include the rotation speed of the input shaft 52 of the transmission, the rotation speed of the output shaft 54, and the hydraulic pressure regulated by the solenoid valve. Also, when the torque or the output of the rotating electric machine is used as the action variable as described in the Regarding Action Variable section, the state simply needs to include the state of charge and the temperature of the battery. Further, when the action includes the load torque of the compressor or the power consumption of the air conditioner as described in the Regarding Action Variable section, the state simply needs to include the temperature in the passenger compartment.

Regarding Reward Calculating Process

The process that provides a greater reward when the energy use efficiency is high than when the energy use efficiency is low is not limited to the process that obtains the difference between 1 and the ratio between a reference efficiency and the efficiency at the actual operating point. Instead, a process may be employed that obtains the difference between the reference efficiency and the efficiency at the actual operating point.

The process that provides a greater reward when the standard related to the acceleration response is met than when the standard is not met is not limited to the process that provides a reward depending on whether the logical conjunction of the condition (a) and the condition (b) is true, or the process that provides a small reward when the condition (c) is met. It is possible to use only one of the process that provides a reward depending on whether the logical conjunction of the condition (a) and the condition (b) is true, and the process that provides a small reward when the condition (c) is met. For example, it is possible to use only the process that provides a reward depending on whether the logical conjunction of the condition (a) and the condition (b) is true. In place of the process that provides a reward depending on whether the logical conjunction of the condition (a) and the condition (b) is true, it is possible to execute a process that provides a reward depending on whether the condition (a) is met and a process that provides a reward depending on whether the condition (b) is met.

For example, instead of providing the same reward without exception when the condition (a) is met, a process may be used that provides a greater reward when the absolute value of the difference between the torque Trq and the torque command value Trq* is small than when the absolute value is large. Also, instead of providing the same reward without exception when the condition (a) is not met, a process may be used that provides a smaller reward when the absolute value of the difference between the torque Trq and the torque command value Trq* is large than when the absolute value is small.

Instead of providing the same reward without exception when the condition (b) is met, a process may be used that varies a reward in accordance with the acceleration Gx. Alternatively, instead of providing the same reward without exception when the condition (b) is not met, a process may be used that varies a reward in accordance with the acceleration Gx.

The reward calculating process does not necessarily include the process that provides a greater reward when the standard related to the acceleration response is met than when the standard is not met, and the process that provides a greater reward when the energy use efficiency meets the standard than when the energy use efficiency does not meet the standard. The reward calculating process may include a process that provides a greater reward when the standard related to the acceleration response is met than when the standard is not met, and a process that provides a greater reward when the state of the passenger compartment meets a standard than when the state of the passenger compartment does not meet the standard. The process that provides a greater reward when the state of the passenger compartment meets a standard than when the state of the passenger compartment does not meet the standard may be a process that provides a greater reward when the intensity of vibration of the vehicle is low than when the intensity is high. Specifically, a process may be used that provides a greater reward when the intensity of vibration of the vehicle is lower than or equal to a predetermined value than when the intensity is higher than the standard. Alternatively, a process may be used that provides a greater reward when the intensity of noise of the vehicle is low than when the intensity of noise of the vehicle is high. For example, a process may be used that provides a greater reward when the intensity of noise of the vehicle is lower than or equal to a predetermined value than when the intensity is higher than the predetermined value.

The reward calculating process may include a process that provides a greater reward when the standard related to the acceleration response is met than when the standard is not met, and a process that provides a greater reward when the exhaust characteristic meets a standard than when the exhaust characteristic does not meet the standard. Also, the reward calculating process may include a process that provides a greater reward when the energy use efficiency meets the standard than when the energy use efficiency does not meet the standard, and a process that provides a greater reward when the exhaust characteristic meets a standard than when the exhaust characteristic does not meet the standard. Further, the reward calculating process may include the following three processes: a process that provides a greater reward when the standard related to the acceleration response is met than when the standard is not met; a process that provides a greater reward when the energy use efficiency meets the standard than when the energy use efficiency does not meet the standard; and a process that provides a greater reward when the exhaust characteristic meets the standard than when the exhaust characteristic does not meet the standard. In short, in a case in which a reward is provided on the basis of multiple standards that can be contrary to one another, relationship-defining data that is more appropriate for the road on which the vehicle is traveling can be learned by changing the method for providing the reward in accordance with the road variable.

When the current value of the solenoid valve of the transmission 50 is used as an action variable as described in the Regarding Action Variable section, the reward calculating process simply needs to include one of the three processes (a) to (c) below.

(a) A process that provides a greater reward when time required for the transmission to change the gear ratio is within a predetermined time than when the required time is exceeds the predetermined time.

(b) A process that provides a greater reward when the absolute value of the rate of change of the rotation speed of the transmission input shaft 52 is less than or equal to an input-side predetermined value than when the absolute value exceeds the input-side predetermined value.

(c) A process that provides a greater reward when the absolute value of the rate of change of the rotation speed of the transmission output shaft 54 is less than or equal to an output-side predetermined value than when the absolute value exceeds the output-side predetermined value.

The process (a) corresponds to the process that provides a greater reward when the acceleration response is high than when the acceleration response is low. The processes (b) and (c) correspond to the process that provides a greater reward when vibration is large than when vibration is small. In other words, the processes (b) and (c) correspond to the process that provides a greater reward when the state of the passenger compartment meets a standard than when the state of the passenger compartment does not meet the standard.

Also, when the torque or the output of the rotating electric machine is used as an action variable as described in the Regarding Action Variable section, the reward calculating process may include a process that provides a greater reward when the state of charge of the battery is within a predetermined range than when the state of charge is out of the predetermined range, and a process that provides a greater reward when the temperature of the battery is within a predetermined range than when the temperature is out of the predetermined range. Further, when the action variable includes the load torque of the compressor or the power consumption of the air conditioner as described in the Regarding Action Variable section, the reward calculating process may include a process that provides a greater reward when the temperature in the passenger compartment is within a predetermined range than when the temperature is out of the predetermined range. This process corresponds to a process that provides a greater reward when the state of the passenger compartment meets a standard than when the state of the passenger compartment does not meet the standard.

Regarding Vehicle Control Data Generating Method

In the process of S34 of FIG. 4, the action is determined on the basis of the action value function Q. However, all the possible actions may be selected with equal probability.

Regarding Control Map Data

The control map data establishes a one-to-one correspondence between the state of the vehicle and the value of the action variable that maximizes the expected return. The control map data then receives the state of the vehicle as an input, and outputs a value of the action variable that maximizes the expected return. The control map data is not limited to the mapping data, but may be a function approximator. As described in the Regarding Update Map section, this is achieved, when the policy gradient method is used, by expressing the policy π using Gaussian distribution presenting the probability of the value of the action variable, expressing the average using a function approximator, updating the parameter of the function approximator expressing the average, and using the learned average as the control map data. The average output by the function approximator is regarded as the value of the action variable that maximizes the expected return. In this case, a function approximator may be provided for each of the values of the road variable VR. Alternatively, the road variable VR may be included in the states s that is an independent variable of a single function approximator.

Regarding Electronic Device

The operated unit of the internal combustion engine that is operated in accordance with an action variable is not limited to throttle valve 14, but may be the ignition device 26 or the fuel injection valve 16.

The electronic devices that are operated in accordance with an action variable include a drive system device between the propelling force generator and the driven wheels. The drive system device is the transmission 50 in the above-described embodiments. However, the drive system device may be the lockup clutch 42.

In a case in which the vehicle includes a rotating electric machine as the propelling force generator as described in the Regarding Propelling Force Generator section, the electronic devices that are operated in accordance with the action variable may include a power converter circuit such as an inverter connected to the rotating electric machine. The operated electronic devices are not limited to electronic devices of an in-vehicle drive system, but may be a vehicle air conditioner. In this case also, if the vehicle air conditioner is driven by rotational force of the propelling force generator, part of the driving force of the propelling force generator that is supplied to the driven wheels 60 depends on the load torque of the vehicle air conditioner. It is thus effective to use the load torque of the vehicle air conditioner as an action variable. Further, if the vehicle air conditioner does not use the rotational force of the propelling force generator, the operation of the vehicle air conditioner affects the energy use efficiency. It is thus effective to use the power consumption of the vehicle air conditioner as an action variable.

Regarding Vehicle Control System

In the example shown in FIGS. 10A and 10B, all the processes of S42 are executed in the data analysis center 130. However, the present disclosure is not limited to this. For example, the data analysis center 130 may execute the processes of S66 to S72 without executing the processes of S52 to S64, which are processes for calculating a reward, and the calculation result of the reward may be transmitted in the process of S110.

In the example shown in FIGS. 10A and 10B, the process for determining the action based on the policy π (the process of S34) is executed in the vehicle. However, the present disclosure is not limited to this. The vehicle VC1 may transmit the data obtained through the process of S32a, and the data analysis center 130 may determine the action a using the transmitted data and transmit the determined action to the vehicle VC1.

The vehicle control system does not necessarily include the controller 70 and the data analysis center 130. In place of the data analysis center 130, a portable terminal of the user may be used. Also, the vehicle control system may include the controller 70, the data analysis center 130, and a portable terminal. This configuration is achieved by executing the process of S34 using the portable terminal.

Regarding Execution Device

The execution device is not limited to a device that includes the CPU 72 (112, 132) and the ROM 74 (114, 134) and executes software processing. For example, at least part of the processes executed by the software in the above-described embodiments may be executed by hardware circuits dedicated to executing these processes such as an application-specific integrated circuit (ASIC). That is, the execution device may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. Multiple software processing devices each including a processor and a program storage device and multiple dedicated hardware circuits may be provided.

Regarding Memory Device

In the above-described embodiments, the memory device storing the relationship-defining data DR and the memory device (ROM 74, 114, 134) storing the learning program 74b, 114a and the control program 74a are separate from each other. However, the present disclosure is not limited to this.

Regarding Internal Combustion Engine

The internal combustion engine is not limited to a spark-ignition engine, but may be a compression ignition engine that uses light oil or the like.

Regarding Propelling Force Generator

The propelling force generator mounted in the vehicle is not limited to an internal combustion engine, but may include an internal combustion engine and a rotating electric machine as in the case of a hybrid vehicle. Further, as in the case of an electric vehicle or a fuel cell vehicle, the propelling force generator may include only a rotating electric machine.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle control data generating method that uses a memory device and an execution device, the method comprising:
storing, in the memory device, relationship-defining data that defines a relationship between a state of a vehicle and an action variable related to an operation of an electronic device in the vehicle; and
with the relationship-defining data stored in the memory device, causing the execution device to execute
an obtaining process that obtains the state of the vehicle based on a detection value of a sensor and a road variable that identifies a road on which the vehicle is traveling,
an operation process that operates the electronic device,
a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard, and
an update process that updates the relationship-defining data by inputting, to a predetermined update map, the state of the vehicle obtained by the obtaining process, the value of the action variable used to operate the electronic device, and the reward corresponding to the operation of the electronic device, wherein
the update map outputs the relationship-defining data that has been updated to increase an expected return of the reward of a case in which the electronic device is operated in accordance with the relationship-defining data, and
values of the road variable include at least a first value and a second value,
the reward calculating process includes a changing process that changes the reward, that is provided when the vehicle has a predetermined characteristic in a case in which the road variable has the second value, in relation to the reward that is provided when the vehicle has the predetermined characteristic in a case in which the road variable has the first value.

2. The vehicle control data generating method according to claim 1, wherein
the road variable identifies that a position is a merging point, at which a general road merges into an expressway, and that a position is on a general road,
the reward calculating process includes two processes, which are
a process that provides a greater reward when a standard related to acceleration response is met than when the standard related to acceleration response is not met, and
a process that provides a greater reward when an energy use efficiency is high than when the energy use efficiency is low, and
the changing process includes a process that changes at least one of the two processes such that, in order to obtain a great reward, it is more advantageous to increase the acceleration response at the merging point than to increase the acceleration response on the general road.

3. The vehicle control data generating method according to claim 1, further comprising:
on a basis of the relationship-defining data that has been updated by the update process, causing the execution device to establish a correspondence between the state of the vehicle and a value of the action variable that maximizes the expected return, thereby generating control map data, wherein the control map data receives the state of the vehicle as an input, and outputs the value of the action variable that maximizes the expected return.

4. A vehicle controller, comprising a memory device and an execution device, the vehicle controller being configured to:
store, in the memory device, relationship-defining data that defines a relationship between a state of a vehicle and an action variable related to an operation of an electronic device in the vehicle; and
with the relationship-defining data stored in the memory device, cause the execution device to execute
an obtaining process that obtains the state of the vehicle based on a detection value of a sensor and a road variable that identifies a road on which the vehicle is traveling,
an operation process that operates the electronic device,
a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard, and
an update process that updates the relationship-defining data by inputting, to a predetermined update map, the state of the vehicle obtained by the obtaining process, the value of the action variable used to operate the electronic device, and the reward corresponding to the operation of the electronic device, wherein
the update map outputs the relationship-defining data that has been updated to increase an expected return of the reward of a case in which the electronic device is operated in accordance with the relationship-defining data,
values of the road variable include at least a first value and a second value,
the reward calculating process includes a changing process that changes the reward, that is provided when the vehicle has a predetermined characteristic in a case in which the road variable has the second value, in relation to the reward, that is provided when the vehicle has the predetermined characteristic in a case in which the road variable has the first value, and
the operation process includes a process that operates the electronic device on a basis of the relationship-defining data and in accordance with a value of the action variable that corresponds to the state of the vehicle.

5. A vehicle control system, comprising an execution device and a memory device, the vehicle control system being configured to:
store, in the memory device, relationship-defining data that defines a relationship between a state of a vehicle and an action variable related to an operation of an electronic device in the vehicle; and
with the relationship-defining data stored in the memory device, causes the execution device to execute
an obtaining process that obtains the state of the vehicle based on a detection value of a sensor and a road variable that identifies a road on which the vehicle is traveling,
an operation process that operates the electronic device,
a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard, and
an update process that updates the relationship-defining data by inputting, to a predetermined update map, the state of the vehicle obtained by the obtaining process, the value of the action variable used to operate the electronic device, and the reward corresponding to the operation of the electronic device, wherein
the update map outputs the relationship-defining data that has been updated to increase an expected return of the reward of a case in which the electronic device is operated in accordance with the relationship-defining data,
values of the road variable include at least a first value and a second value,
the reward calculating process includes a changing process that changes the reward, that is provided when the vehicle has a predetermined characteristic in a case in which the road variable has the second value, in relation to the reward, that is provided when the vehicle has the predetermined characteristic in a case in which the road variable has the first value,
the operation process includes a process that operates the electronic device on a basis of the relationship-defining data and in accordance with a value of the action variable that corresponds to the state of the vehicle,
the execution device includes a first execution device mounted on the vehicle and a second execution device that is an out-of-vehicle device,
the first execution device executes at least the obtaining process and the operation process, and
the second execution device executes at least the update process.

6. A vehicle controller employed in a vehicle control system, wherein
the vehicle control system includes an execution device and a memory device,
the vehicle controller is configured to:
store, in the memory device, relationship-defining data that defines a relationship between a state of a vehicle and an action variable related to an operation of an electronic device in the vehicle; and
with the relationship-defining data stored in the memory device, causes the execution device to execute
an obtaining process that obtains the state of the vehicle based on a detection value of a sensor and a road variable that identifies a road on which the vehicle is traveling,
an operation process that operates the electronic device,
a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard, and
an update process that updates the relationship-defining data by inputting, to a predetermined update map, the state of the vehicle obtained by the obtaining process, the value of the action variable used to operate the electronic device, and the reward corresponding to the operation of the electronic device,
the update map outputs the relationship-defining data that has been updated to increase an expected return of the reward of a case in which the electronic device is operated in accordance with the relationship-defining data,
values of the road variable include at least a first value and a second value,
the reward calculating process includes a changing process that changes the reward, that is provided when the vehicle has a predetermined characteristic in a case in which the road variable has the second value, in relation to the reward, that is provided when the vehicle has the predetermined characteristic in a case in which the road variable has the first value,
the operation process includes a process that operates the electronic device on a basis of the relationship-defining data and in accordance with a value of the action variable that corresponds to the state of the vehicle,
the execution device includes a first execution device mounted on the vehicle and a second execution device that is an out-of-vehicle device,
the first execution device executes at least the obtaining process and the operation process,
the second execution device executes at least the update process, and
the vehicle controller includes the first execution device.

7. A vehicle learning device employed in a vehicle control system, wherein
the vehicle control system includes an execution device and a memory device,
the vehicle controller is configured to:
store, in the memory device, relationship-defining data that defines a relationship between a state of a vehicle and an action variable related to an operation of an electronic device in the vehicle; and
with the relationship-defining data stored in the memory device, causes the execution device to execute
an obtaining process that obtains the state of the vehicle based on a detection value of a sensor and a road variable that identifies a road on which the vehicle is traveling,
an operation process that operates the electronic device,
a reward calculating process that causes, on a basis of the state of the vehicle obtained by the obtaining process, a reward, that is provided when a characteristic of the vehicle meets a standard, to be larger than a reward that is provided when the characteristic of the vehicle does not meet the standard, and
an update process that updates the relationship-defining data by inputting, to a predetermined update map, the state of the vehicle obtained by the obtaining process, the value of the action variable used to operate the electronic device, and the reward corresponding to the operation of the electronic device,
the update map outputs the relationship-defining data that has been updated to increase an expected return of the reward of a case in which the electronic device is operated in accordance with the relationship-defining data,
values of the road variable include at least a first value and a second value,
the reward calculating process includes a changing process that changes the reward, that is provided when the vehicle has a predetermined characteristic in a case in which the road variable has the second value, in relation to the reward, that is provided when the vehicle has the predetermined characteristic in a case in which the road variable has the first value,
the operation process includes a process that operates the electronic device on a basis of the relationship-defining data and in accordance with a value of the action variable that corresponds to the state of the vehicle,
the execution device includes a first execution device mounted on the vehicle and a second execution device that is an out-of-vehicle device,
the first execution device executes at least the obtaining process and the operation process,
the second execution device executes at least the update process, and
the vehicle learning device includes the second execution device.
